(19) United States
(12) Patent Application Publication
(10) Pub. No.: US 2024/0420011 A1
(43) Pub. Date: Dec. 19, 2024

(54) VECTORIZATION PROCESS AND FEATURE STORE FOR VECTOR STORAGE

(71) Applicant: The Toronto-Dominion Bank, Toronto (CA)

(72) Inventors: Judith Tamara Cirulis, Toronto (CA); Chad A. Koziel, Toronto (CA); Paulina Corona Ugalde, Toronto (CA); Shiyi Hou, Toronto (CA); Ted Li, Toronto (CA); Maniganden Chandrasekaran, Toronto (CA); Shivangi Soni, Toronto (CA)

(73) Assignee: The Toronto-Dominion Bank, Toronto, ON (CA)

(21) Appl. No.: 18/333,675

(22) Filed: Jun. 13, 2023

(51) Int. Cl. G06N 20/00

(52) U.S. Cl. CPC G06N 20/00

(57) ABSTRACT

An example operation may include one or more of receiving a query parameter input via an interface of a software application, querying the feature store based on the query parameter, wherein the querying comprises identifying one or more vectors stored in the features store that match the query parameter via execution of a query on the feature store, executing a machine learning model on the one or more vectors identified in the feature store to generate a predicted output, and displaying the predicted output via the interface of the software application.

### BACKGROUND

Merchants are currently represented by a transaction description in the form of a string of text. These strings by themselves have no meaning, no relationship information, and no structure. As a result, making use of the transaction descriptions can be difficult.

### SUMMARY

One example embodiment provides an apparatus that may include a storage device that includes a feature store and a processor configured to one or more of query data of a merchant read from a point of sale (POS) system of the merchant and convert the data into an encoding, execute a machine learning model on the encoding to generate a vector that comprises vectorized values corresponding to latent features of the merchant embedded within slots of the vector, respectively, generate an entry comprising an identifier of the merchant, context of the merchant, and the generated vector, and store the entry in the feature store.

Another example embodiment provides a method that includes one or more of querying data of a merchant read from a point of sale (POS) system of the merchant and converting the data into an encoding, executing a machine learning model on the input encoding to generate a vector that comprises vectorized values corresponding to latent features of the merchant embedded within slots of the vector, respectively, generating an entry comprising an identifier of the merchant, context of the merchant, and the generated vector, and storing the entry in the feature store.

Another example embodiment provides a computer-readable medium comprising instructions, that when read by a processor, cause the processor to perform one or more of querying data of a merchant read from a point of sale (POS) system of the merchant and converting the data into an encoding, executing a machine learning model on the input encoding to generate a vector that comprises vectorized values corresponding to latent features of the merchant embedded within slots of the vector, respectively, generating an entry comprising an identifier of the merchant, context of the merchant, and the generated vector, and storing the entry in the feature store.

Another example embodiment provides an apparatus that may include a storage device that includes a feature store, and a processor that may receive a query parameter input via an interface of a software application, query the feature store based on the query parameter, wherein the querying comprises identifying one or more vectors stored in the features store that match the query parameter via execution of a query on the feature store, execute a machine learning model on the one or more vectors identified in the feature store to generate a predicted output, and display the predicted output via the interface of the software application.

Another example embodiment provides a method that includes one or more of receiving a query parameter input via an interface of a software application, querying the feature store based on the query parameter, wherein the querying comprises identifying one or more vectors stored in the features store that match the query parameter via execution of a query on the feature store, executing a machine learning model on the one or more vectors identified in the feature store to generate a predicted output, and displaying the predicted output via the interface of the software application.

And yet a further example embodiment provides a computer-readable medium comprising instructions that, when read by a processor, cause the processor to perform one or more of receiving a query parameter input via an interface of a software application, querying the feature store based on the query parameter, wherein the querying comprises identifying one or more vectors stored in the features store that match the query parameter via execution of a query on the feature store, executing a machine learning model on the one or more vectors identified in the feature store to generate a predicted output, and displaying the predicted output via the interface of the software application.

### BRIEF DESCRIPTION OF THE DRAWINGS

FIG. 1 is a diagram illustrating a host platform for vectorization and vector storage according to example embodiments.

FIGS. 2A-2B are diagrams illustrating a process of training a machine learning model and vectorizing data based on the trained machine learning model according to example embodiments.

FIG. 2C is a diagram illustrating a process of converting transaction data into a vector according to example embodiments.

FIG. 3A is a diagram illustrating a permissioned network, according to example embodiments.

FIG. 3B is a diagram illustrating another permissioned network, according to example embodiments.

FIG. 3C is a diagram illustrating a further permissionless network, according to example embodiments.

FIG. 3D is a diagram illustrating machine learning process via a cloud computing platform, according to example embodiments.

FIGS. 4A-4B are diagrams illustrating a process of querying a feature store of a host platform for input vectors according to example embodiments.

FIG. 5 is a diagram illustrating a process of executing a machine learning model on vectors queried from a features store according to example embodiments.

FIG. 6 is a diagram illustrating a process of converting transaction data into a customer vector according to example embodiments.

FIG. 7 is a diagram illustrating a method of generating a vector for a merchant based on historical transaction data according to example embodiments.

FIG. 8 is a diagram illustrating a method of executing a machine learning model on vectors queried from a feature store according to example embodiments.

FIG. 9 is a diagram illustrating an example system that supports one or more of the example embodiments.

### DETAILED DESCRIPTION

It will be readily understood that the instant components, as generally described and illustrated in the figures herein, may be arranged and designed in various configurations. Thus, the following detailed description of the embodiments of at least one of a method, apparatus, non-transitory computer readable medium, and system, as represented in the attached figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language throughout this specification do not necessarily all refer to the same group of embodiments. The described features, structures, or characteristics may be combined or removed in any suitable manner in one or more embodiments. Further, in the diagrams, any connection between elements can permit one-way and/or two-way communication, even if the depicted connection is a one-way or two-way arrow. Also, any device depicted in the drawings can be a different device. For example, if a mobile device is shown sending information, a wired device could also be used to send the information.

In addition, while the term “message” may have been used in the description of embodiments, the application may be applied to many types of networks and data. Furthermore, while certain types of connections, messages, and signaling may be depicted in exemplary embodiments, the application is not limited to a certain type of connection, message, and signaling.

Example embodiments provide methods, systems, components, non-transitory computer readable media, devices, and/or networks, directed to a host system that can generate vector representations for merchants, which can be used during payment network processing, fraud analysis, recommendations, and the like. The host system may host a machine learning model such as a word-to-vector (Word2Vec) model that can be used to convert natural language input into a format that can be processed by a computer processor (i.e., a vector). In one example, the model may include a skip-gram model, but embodiments are not limited thereto.

The machine learning model may execute on the historical data of a merchant to derive a vector that represents the merchant, wherein the data may be transaction data. For example, the machine learning model may receive historical payment data associated with the merchant as input and generate a vector that represents the merchant in response. For example, attributes such as transaction times, transaction amounts, processing times, products sold, and the like may be input to the machine learning model. Other attributes of the merchant may also be input, such as a merchant category code (MCC) and the like. The machine learning model may embed the input data into a vector.

The host system described herein may have access to payment data, such as payment card data submitted through an electronic payment network. In some embodiments, the host system may be a payment processor or other member of the payment network, but embodiments are not limited thereto. To create a vector for a merchant, the host system may receive or otherwise generate a table of data for input to a machine learning model such as the Word2Vec model mentioned above. The table of data may include data (such as transaction data) from a plurality of payment transactions. Each transaction may include a timing value (e.g., timestamp, order number, etc.) that puts the data into a time-series order, a target being described such as a merchant or a customer, event data such as transaction data (e.g., transaction amount, location, call reason, webpage description, device category, etc.) that provides information about the event/action that took place at each time point, and the like.

The Word2Vec model may convert the descriptive data (e.g., text, values, characters, etc.) into numbers (e.g., fractional values, etc.) that can be embedded within a vector. The resulting vector represents the target (e.g., the merchant, the customer, etc.) in a higher dimensional space, with each dimension containing information about the latent attributes of the target. However, the process does not have a predefined mapping of each dimension. Therefore it can vary. For example, a cell might represent a geographic location of the target, another cell might represent the product type sold or purchased by the target, etc., but there is no definition of what the vector cells include.

For example, the machine learning model may output a word vector of a predetermined size (e.g., 50 slots, 100 slots, 200 slots, 250, etc.) The size of merchant vectors can be easily adjusted. Also, the size of the merchant vectors may be the same. During experimentation, word vectors having a size of 250 slots were the most effective and efficient. However, embodiments are not limited thereto. Within the merchant vector, the slots store decimal values that represent latent features about the merchant, and the number of slots is controlled by a model hyperparameter called vector size. Each slot does not have a specific semantic meaning on its own. Instead, the meaning of the slot is determined by the relationship between vectors of different words in the high-dimensional space.

The input data for generating the merchant vector may include a data frame that includes multiple columns, including a first column of account number and a second column with a list of transactions/transaction information (such as merchant name, time of transaction, etc.) for that account. The output vector size is a model hyperparameter that can be chosen. As an example, a model output with higher vector size (250) would have more information being captured as compared to a model with a lower vector size (50).

The input data is all standardized to be the same size. In some cases, the input data size is independent of the output merchant vector size. Matrix multiplications occur within the Skip Gram algorithm, which requires input sizes to be consistent and ensures the generated vectors are consistent of the size set with the hyperparameters. The input word does not map directly to slots in the vectors. Instead, the underlying characteristics of the merchant words get mapped to slots in the vector. These underlying characteristics are not explicitly defined from the model output, but some examples of these underlying characteristics are the location of the merchant, the type of business, etc. Furthermore, the input data might not even have the underlying characteristics explicitly within them. For example, a geographic location where a transaction occurred may not be present in the input data. However, a group of transactions may have this information hidden and initially inaccessible to us, and the model will extract and capture it based on relationships/patterns in the data. The matrix multiplication that happens creates the numbers that get embedded into the vectors. It's not random. But due to the high dimensionality and size of the calculation, a person cannot identify nor explain the meaning of each vector slot.

The vector may be stored within a feature store along with other merchant vectors until needed for subsequent processing. For example, the feature store may have an interface and a search engine that enables a user to input search criteria into the interface and search for vectors matching particular query parameters associated with a merchant, such as a merchant category code (MCC), merchant type, product type(s), geographic location, and the like. In some cases, the vector may be retrieved from the feature store and input into a machine learning model for different purposes, including training a machine learning model, generating a predicted output based on input data, etc.

Traditionally, merchants are represented with merchant category codes (MCC) which represent the types of products and services that a merchant offers. However, the number of MCC codes is limited (e.g., less than 1000), and they do not consider other aspects of the merchant, such as geographic location, time periods, sales data, and the like. The merchant vector described herein can provide significantly more information about the merchant than an MCC code. Furthermore, the vectorization process can be applied to existing data held by a payment processor or other entity, thus converting strings of text/financial transactions into numerical embeddings within a vector.

By standardizing merchant data into vectors, a significant amount of storage space is saved because text data (string data) is converted into numbers (decimal data) that are much smaller in size. Furthermore, the data is anonymous. Therefore, the vectors are already in a format that satisfies government regulations and privacy laws that require the use of de-identified data during modeling. Here, the vectors are ideal for this as the cells contain information. Still, it's uninterpretable by looking at just the vector and can't be queried with data points to identify a person. For example, a viewer can't enter an address, age, and/or transaction amount and find people who meet these criteria.

Furthermore, the vectors may be stored in a feature store that is coupled to a development environment. Thus, a readily available algorithmic generated feature store may be used to ease manual efforts to create new features based on the available data because the features are available and ready in the features store. Furthermore, the vectors contain much more latent information about the merchant that machine learning algorithms can draw upon compared to a traditional MCC code. As with most model development systems, there is a chance for bias when training a model due to this latent information, so validation and bias checking may be performed to ensure the model lacks bias.

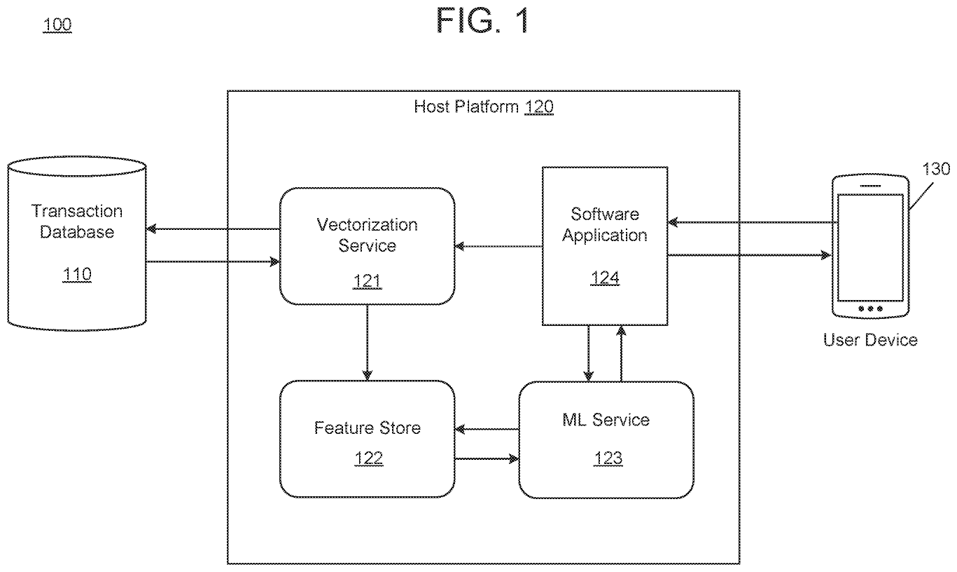

FIG. 1 illustrates a computing environment 100 which includes a host platform 120 for vectorization and vector storage according to example embodiments. Referring to FIG. 1, the host platform 120 may be a cloud platform, a web server, a database, an on-premises server, a combination of systems, and the like. Here, the host platform 120 may host a software application 124, such as a mobile application, web application, etc., which can be downloaded and installed by user devices such as user device 130. Here the user device 130 may install a front-end of the software application 124 and interact with a back-end of the software application 124 hosted on the host platform 120.

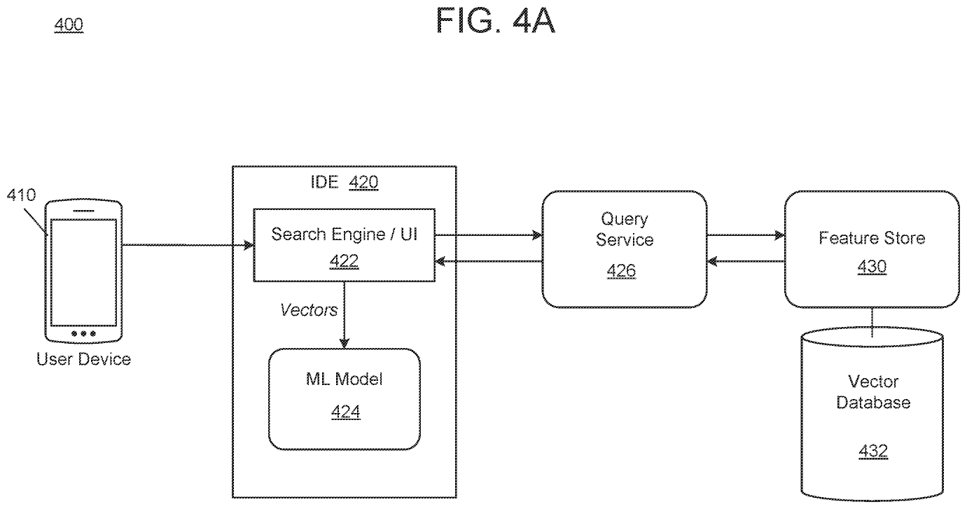

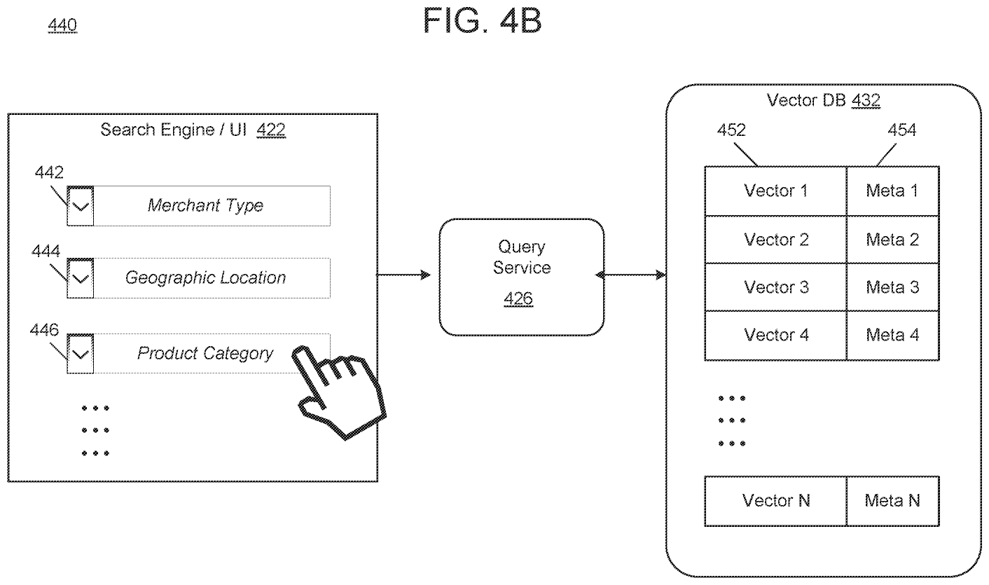

The host platform 120 also includes a vectorization service 121 that is capable of converting string data (e.g., banking account transaction data, etc.) into a vector. The resulting vector may be stored/held in a feature store 122, where it can be stored with a label or other metadata which identifies attributes of the merchant, including a merchant name, a product type, a geographic location, etc. This label may be paired with the vector in the feature store 122 thus providing context in association with the vector. The context can be used to search for and find vectors that meet a specific search criteria, such as a merchant that sells a particular product type or a merchant in a particular geographic location. The search criteria and search process if further described herein with respect to FIGS. 4A and 4B.

Referring again to FIG. 1, the user device 130 may submit a request to generate a new vector to the software application 124. The request may identify a particular merchant or customer and may be submitted via an application programming interface (API), or the like of the software application 124. The software application 124 may trigger the creation of the vector based on a particular identifier of the merchant or customer provided to the software application 124 from the user device 130. For example, the software application 124 may trigger the vectorization service 121 to query data stored in a transaction database 110 to find data associated with the particular merchant or customer that is identified. This data may then be fed into a machine learning model of the vectorization service (such as a Word2Vec model), which converts the data into a vector. The vectorization service 121 may generate metadata associated with the vector, such as a merchant identifier, a merchant type (product type, etc.), a merchant location, a MCC code, sales time data, sales amount data, and the like, and store the vector with the metadata in the feature store 122. The metadata is a searchable description/label associated with the vector.

In addition to generating vectors, the host platform 120 may develop new machine learning models and update existing machine learning models via a ML service 123 which may provide a development environment for model training. For example, the user device 130 may provide a search criteria to the software application 124, which instructs the ML service 123 to retrieve vectors from the feature store 122 that satisfy the search criteria. The vectors returned from the feature store can be used to train a machine learning model. For example, the model may be iteratively executed on different vectors from the feature store 122 to learn additional features about merchants, customers, cardholders, and the like.

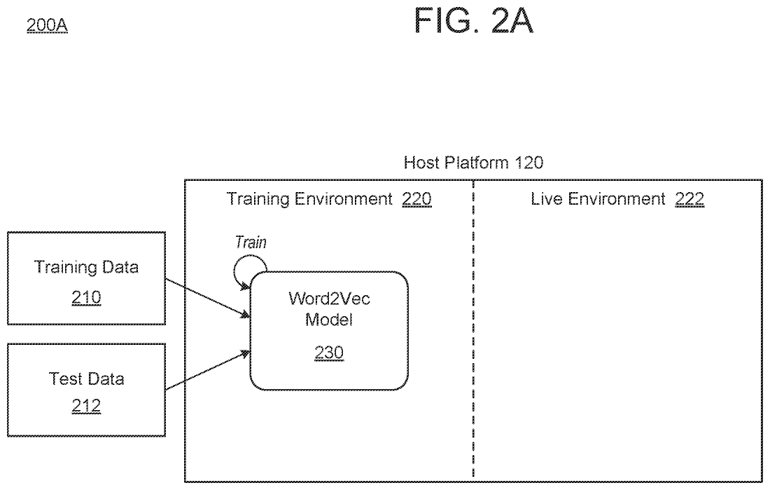

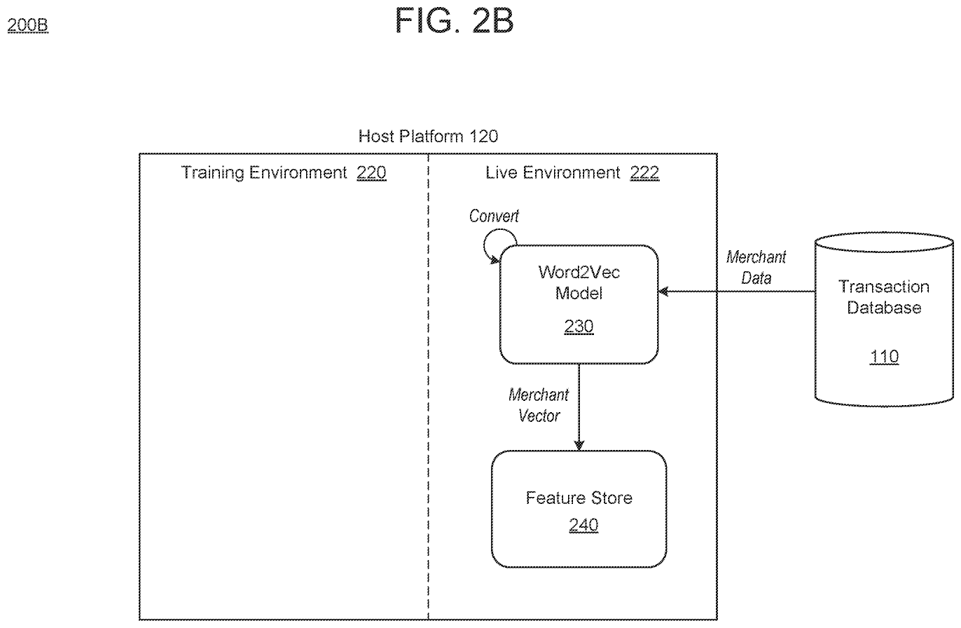

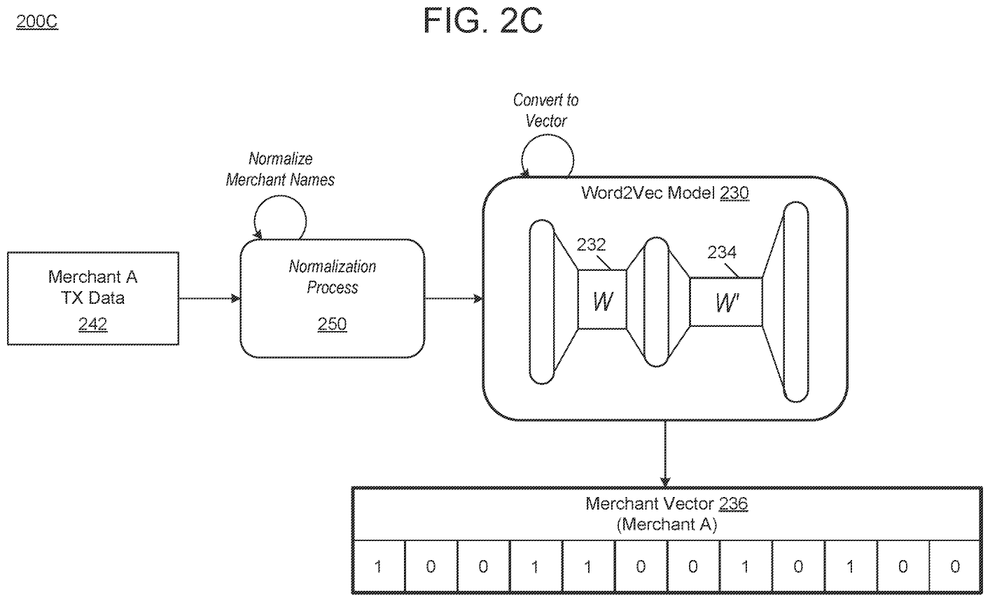

FIGS. 2A-2B illustrates processes of training a machine learning model 230 and vectorizing data based on the trained machine learning model according to example embodiments. For example, FIG. 2A illustrates a process 200A of training a machine learning model 230 to convert text data (string data) into a vector such as a merchant vector or a customer vector. Here, a host platform, such as the host platform 120 shown in FIG. 1, includes different operating environments, including a training environment 220 and a live runtime environment 222, which is available over a network such as the Internet. During the training process, the developer may interact with the machine learning model 230 in the training environment 220.

For example, the machine learning model 230 may be a feedforward neural network (skip gram, CBOW, etc.) that includes an input layer, a hidden layer(s), and an output layer. The training process may include feeding the machine learning model 230 a number of training samples from training data 210, including central words and context words associated with the central words. The machine learning model 230 is of the unsupervised type, and therefore the training process requires a very large data set and may include numerous iteration cycles of adjusting the model weights until the error of the output prediction has been minimized. Furthermore, the training process may include testing the model using a test input and a known output value from test data 212. For example, the system may input a test into machine learning model 230 to generate a predicted output (vector embedding). This may be compared to a known output (known vector embedding) of the input, which is included in the test data 212.

There is no known vector embedding. Word2Vec is an “unsupervised” model, meaning that there are no labels/ground truth used for determining the model parameters. For this stage (vector generation), there is no test data. However, a supervised machine learning model can be built using the vectors generated as input, and a test set can be used on this supervised ML model, and the performance of this model can imply how useful/effective these vectors are. Meanwhile, testing the merchant vectors themselves requires a downstream task to assess the lift these vectors provide. Validating/confirming the merchant vectors is not really possible because they're the middle vector used in all the math. Meanwhile, it is possible to test the model. For example, a small test set may be input and then observed to identify how accurate the output prediction vectors are when using optimized weights and merchant vectors.

Thus, the developer may evaluate the loss of the model prediction based on a known output of the training sample from test data 212 versus the predicted output value generated by the machine learning model 230. For example, the model weights may then be updated using gradient descent on the evaluated loss. The process may be repeated with new samples until the developer reaches a desired level of training.

Referring now to FIG. 2B, a process 200B of hosting the training machine learning model 230 is shown. With the machine learning model 230 now trained, the model can be used to generate vectors, including merchant vectors and customer vectors. For example, the machine learning model 230 could convert a historical database of merchant transactions into a single vector representation that captures the latent features within the historical transactions. In FIG. 2B, the machine learning model 230 (or host service thereof) queries a transaction database 110 for transactions associated with a merchant or customer. This data is then input into the machine learning model 230, which embeds into a vector. The vector is then stored in a feature store 240, where it is accessible for subsequent training and processing purposes.

The model architecture is not new, but the process of generating an analogy between words and merchant texts and generating an analogy between transaction sequences to word sentences is new. In some embodiments, each merchant may be given a unique vector representation (e.g., one-to-one mapping between merchant names and vectors). The data used to generate these vectors is a modeler's choice, and it has, at a minimum, the merchant names and can contain features like the day of the week, amount bracket, merchant category code, etc. The sequential information is fed into the word2vec model, which uses the sequential context to generate vectors/embeddings. Once the model is trained, each merchant is assigned to an embedding in the high-dimensional space (e.g., vector space). The vectors for similar merchants will be closer to each other in the vector space, allowing for semantic relationships to be identified and used for subsequent actions and steps.

FIG. 2C illustrates a process 200C of converting data into a vector 236 according to example embodiments, wherein the data may be transaction data. For example, the process 200C may be performed via execution of a machine learning model (Word2Vec model 230) on merchant data 242, such as historical transaction data, to generate the vector 236, which may be associated with the merchant. As another example, the Word2Vec model 230 may be executed on merchant data 242, such as historical transaction data, to generate a customer vector associated with a customer of the merchant based on transaction data of the customer.

Prior to inputting the merchant data 242 into the Word2Vec model 230, the merchant data may be normalized via a normalization process 250. Data/strings may be cleaned and normalized during the normalization process based on merchant names. For example, four different merchant names, “mile_esso,” “esso_travel,” “esso_dum” and “esso” may each be normalized into one common merchant name (i.e., “esso”). In doing so, the normalization process 250 can reduce the amount of merchant names considered by the machine learning model and increase the amount of features that are mapped to each merchant, thereby improving model accuracy.

The normalized merchant data may be encoded prior to inputting the normalized merchant data into the Word2Vec model 230. Here, the input data may be high-dimensional one-hot-encoded sparse vectors, consisting of 1 in one of the positions in the vector to identify the merchant and 0 elsewhere. The input vectors are of dimension V, which is the number of unique merchant names in the training corpus. The raw outputs are V-dimensional dense vectors, which consist of V decimal numbers in each of the V positions in the vector, because of the use of a softmax activation function. Next, the raw output vectors are converted into V-dimensional sparse vectors containing one “1” and V-1 “0”s. The position at which “1” occurs identifies one specific neighboring word, aka. the context. What's learned by the Word2Vec model 230 is the two weight matrices (232 and 234). Here, the weight matrix 232 may be used to generate the final merchant embeddings. Each word embedding is obtained by multiplying its corresponding one-hot-encoded input vectors to the final weight matrix 232. The weight learning process may include back propagation, gradient descent, and negative sampling.

The resulting vector 236 includes “embeddings,” which refers to the process of having text data converted into decimal form and stored into vectors. For example, the Word2Vec model 230 may transform the merchant name STARBUCKS® into a vector: (0.5, 0.2, . . . , 0.6). By just having raw merchant text (i.e., a text string), the system does not know a spending pattern of customers or a relationship between merchants. However, with vectors, much more information can be embedded and used for identifying and understanding a merchant or a customer. The term “meaningful embeddings” refers to the vectors themselves, which include transforming merchant data, names, values, etc., into vector form. For example, the vector can capture relationships between merchants, a merchant's primary business, the geographic location of the merchant, sales amounts, sales times, etc.

When the vectors are analyzed in vector space, the vectors with similar contexts will be visually clustered near each other. Thus, similar merchants or similar customers can easily be identified in vector space, for example, using another machine learning model. This method can be used to manually validate how similar merchants are placed together because of this underlying pattern. A vector may refer to a merchant embedding, and each value in the vector may represent a dimension of the merchant. The vector can quantity semantic similarities based on a given input. So, a vector for any given merchant will best represent the merchant in a higher dimensional space. These dimensions contain information about the latent attributes of that merchant. A simple real-world example of a word2vec embedding is

$$[ king ] - [ man ] = [ queen ] - [ woman ]$$

Meanwhile, MCC codes do not contain any of this data. Rather, an MCC code represents a category of the merchant. However, all analyses done using these codes directly will contain the same inconsistencies, so by creating merchant vectors, the host system can now identify and categorize similar merchants. Some of the benefits of vectors vs codes can be summarized as vectors are less subjective. “Merchant vectors” are learned vectors based on how people use the merchant, while merchant codes are manually assigned tags based on people's understanding of the merchants. Vectors enable the important hidden information contained in customers' transactions to be leveraged, such as a sequence of merchants (airport, taxi, hotel, restaurant). Another improvement is that “vectors” have more dimensions compared with “codes” and thus could carry a more meaningful representation of the merchants compared with “codes.” Also, multiple-dimensioned “vectors” are more suitable as modeling inputs compared with a single “code.” Effectively with vectors, the host system can create a feature specific to each merchant, not grouped at the MCC level, and not requiring only one feature per merchant as the MCC code does.

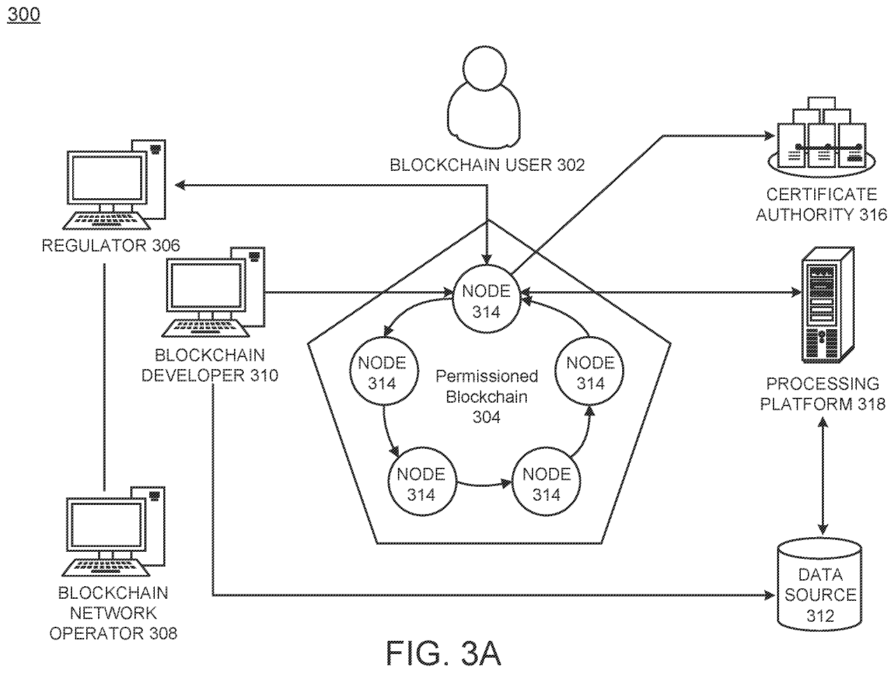

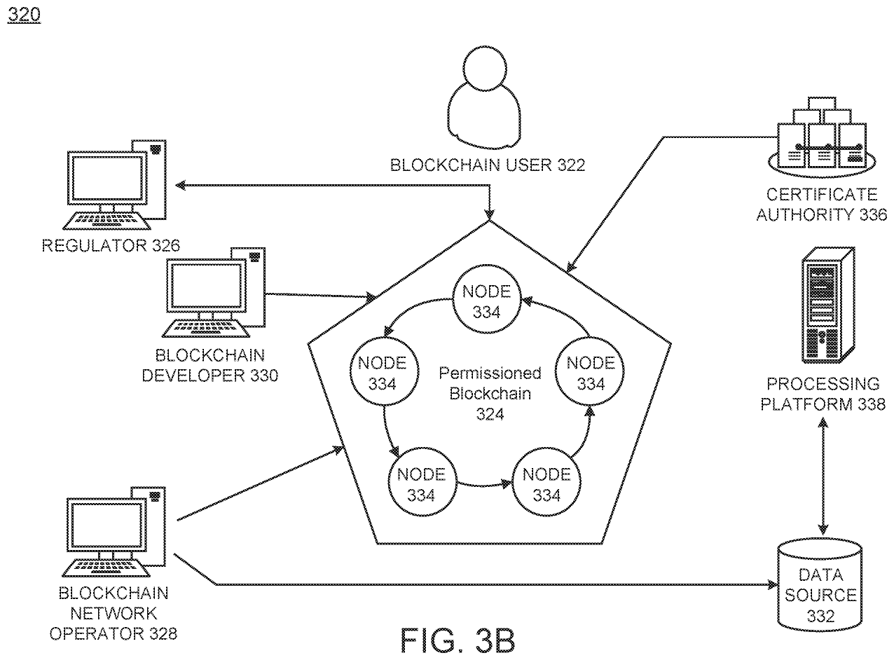

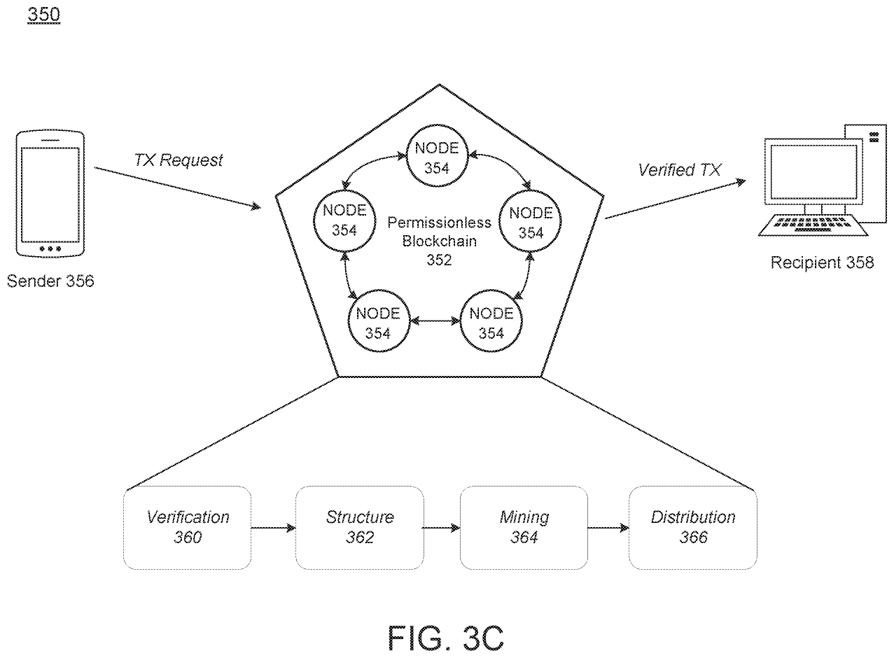

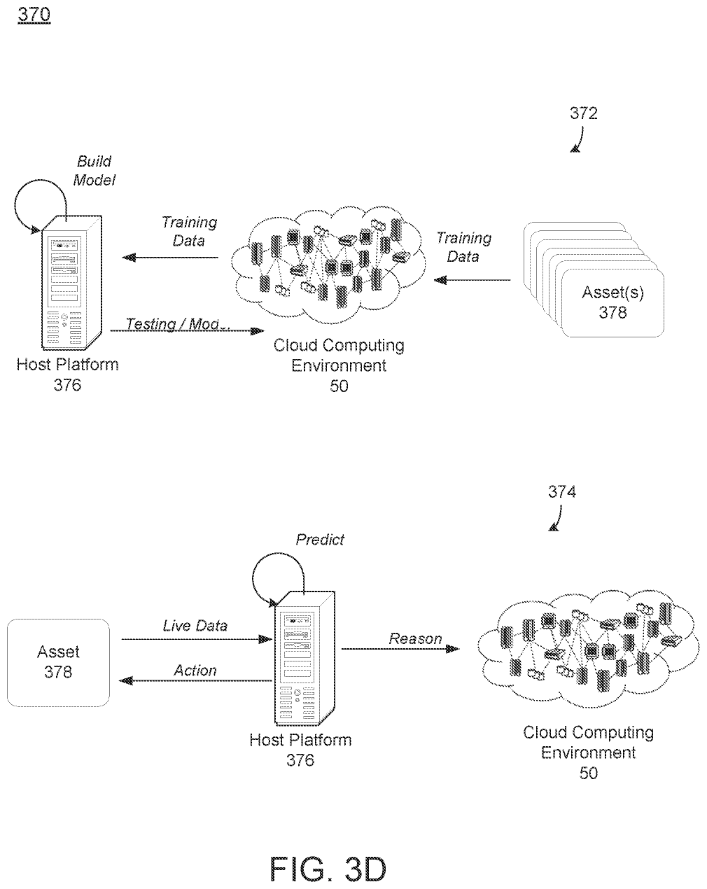

FIG. 3A illustrates an example of a permissioned blockchain network 300, which features a distributed, decentralized peer-to-peer architecture. The blockchain network may interact with the cloud computing environment 160, allowing additional functionality such as peer-to-peer authentication for data written to a distributed ledger. In this example, a blockchain user 302 may initiate a transaction to the permissioned blockchain 304. In this example, the transaction can be a deploy, invoke, or query and may be issued through a client-side application leveraging an SDK, directly through an API, etc. Networks may provide access to a regulator 306, such as an auditor. A blockchain network operator 308 manages member permissions, such as enrolling the regulator 306 as an “auditor” and the blockchain user 302 as a “client.” An auditor could be restricted only to querying the ledger, whereas a client could be authorized to deploy, invoke, and query certain types of chaincode.

A blockchain developer 310 can write chaincode and client-side applications. The blockchain developer 310 can deploy chaincode directly to the network through an interface. To include credentials from a traditional data source 312 in chaincode, the developer 310 could use an out-of-band connection to access the data. In this example, the blockchain user 302 connects to the permissioned blockchain 304 through a peer node 314. Before proceeding with any transactions, the peer node 314 retrieves the user's enrollment and transaction certificates from a certificate authority 316, which manages user roles and permissions. In some cases, blockchain users must possess these digital certificates in order to transact on the permissioned blockchain 304. Meanwhile, a user attempting to utilize chaincode may be required to verify their credentials on the traditional data source 312. To confirm the user's authorization, chaincode can use an out-of-band connection to this data through a traditional processing platform 318.

FIG. 3B illustrates another example of a permissioned blockchain network 320, which features a distributed, decentralized peer-to-peer architecture. In this example, a blockchain user 322 may submit a transaction to the permissioned blockchain 324. In this example, the transaction can be a deploy, invoke, or query and may be issued through a client-side application leveraging an SDK, directly through an API, etc. Networks may provide access to a regulator 326, such as an auditor. A blockchain network operator 328 manages member permissions, such as enrolling the regulator 326 as an “auditor” and the blockchain user 322 as a “client”. An auditor could be restricted only to querying the ledger, whereas a client could be authorized to deploy, invoke, and query certain types of chaincode.

A blockchain developer 330 writes chaincode and client-side applications. The blockchain developer 330 can deploy chaincode directly to the network through an interface. To include credentials from a traditional data source 332 in chaincode, the developer 330 could use an out-of-band connection to access the data. In this example, the blockchain user 322 connects to the network through a peer node 334. Before proceeding with any transactions, the peer node 334 retrieves the user's enrollment and transaction certificates from the certificate authority 336. In some cases, blockchain users must possess these digital certificates in order to transact on the permissioned blockchain 324. Meanwhile, a user attempting to utilize chaincode may be required to verify their credentials on the traditional data source 332. To confirm the user's authorization, chaincode can use an out-of-band connection to this data through a traditional processing platform 338.

In some embodiments, the blockchain herein may be a permissionless blockchain. In contrast with permissioned blockchains, which require permission to join, anyone can join a permissionless blockchain. For example, to join a permissionless blockchain, a user may create a personal address and begin interacting with the network by submitting transactions and hence adding entries to the ledger. Additionally, all parties can run a node on the system and employ the mining protocols to help verify transactions.

FIG. 3C illustrates a process 350 of a transaction being processed by a permissionless blockchain 352, including a plurality of nodes 354. A sender device 356 desires to send payment or some other form of value (e.g., a deed, medical records, a contract, a good, a service, or any other asset that can be encapsulated in a digital record) to a recipient device 358 via the permissionless blockchain 352. In one embodiment, each of the sender device 356 and the recipient device 358 may have digital wallets (associated with the permissionless blockchain 352) that provide interface controls and a display of transaction parameters. In response, the transaction is broadcast throughout the permissionless blockchain 352 to the nodes 354. Depending on the permissionless blockchain's 352 network parameters, the nodes verify 360 the transaction based on rules (which may be pre-defined or dynamically allocated) established by the permissionless blockchain 352 creators. For example, this may include verifying the parties' identities, etc. The transaction may be verified immediately or placed in a queue with other transactions, and the nodes 354 determine if the transactions are valid based on a set of network rules.

In structure 362, valid transactions are formed into a block and sealed with a lock (hash). Mining nodes may perform this process among the nodes 354. Mining nodes may utilize additional software specifically for mining and creating blocks for the permissionless blockchain 352. Each block may be identified by a hash (e.g., 256-bit number, etc.) created using an algorithm agreed upon by the network. Each block may include a header, a pointer or reference to a hash of a previous block's header in the chain, and a group of valid transactions. The reference to the previous block's hash is associated with the creation of the secure independent chain of blocks.

Before blocks can be added to the blockchain, the blocks must be validated. Validation for the permissionless blockchain 352 may include a proof-of-work (PoW), a solution to a puzzle derived from the block's header. Although not shown in the example of FIG. 3C, another process for validating a block is proof-of-stake. Unlike the proof-of-work, where the algorithm rewards miners who solve mathematical problems with the proof of stake, a creator of a new block is chosen in a deterministic way, depending on its wealth, also defined as “stake.” Then, a similar proof is performed by the selected/chosen node.

With mining 364, nodes try to solve the block by making incremental changes to one variable until the solution satisfies a network-wide target. This creates the PoW, thereby ensuring correct answers. In other words, a potential solution must prove that computing resources were drained in solving the problem. In some types of permissionless blockchains, miners may be rewarded with value (e.g., coins, etc.) for correctly mining a block.

Here, the PoW process, alongside the chaining of blocks, makes modifications of the blockchain extremely difficult, as an attacker must modify all subsequent blocks to accept the modifications of one block. Furthermore, as new blocks are mined, the difficulty of modifying a block increases, and the number of subsequent blocks increases. With distribution 366, the successfully validated block is distributed through the permissionless blockchain 352, and all nodes 354 add the block to a majority chain which is the permissionless blockchain's 352 auditable ledger. Furthermore, the value in the transaction submitted by the sender device 356 is deposited or otherwise transferred to the digital wallet of the recipient device 358.

FIG. 3D illustrates an example 370 of a cloud computing environment 50, which stores machine learning (artificial intelligence) data. Machine learning relies on vast quantities of historical data (or training data) to build predictive models for accurate prediction on new data. Machine learning software (e.g., neural networks, etc.) can often sift through millions of records to unearth non-intuitive patterns.

In the example of FIG. 3D, a host platform 376, builds and deploys a machine learning model for predictive monitoring of assets 378. Here, the host platform 366 may be a cloud platform, an industrial server, a web server, a personal computer, a user device, and the like. Assets 378 can be any asset (e.g., machine or equipment, etc.) such as an aircraft, locomotive, turbine, medical machinery and equipment, oil and gas equipment, boats, ships, vehicles, and the like. As another example, assets 378 may be non-tangible assets such as stocks, currency, digital coins, insurance, or the like.

The cloud computing environment 50 can be used to significantly improve both a training process 372 of the machine learning model and a predictive process 374 based on a trained machine learning model. For example, in 372, rather than requiring a data scientist/engineer or another user to collect the data, historical data may be stored by the assets 378 themselves (or through an intermediary, not shown) on the cloud computing environment 50. This can significantly reduce the collection time the host platform 376 needs when performing predictive model training. For example, data can be directly and reliably transferred straight from its place of origin to the cloud computing environment 50. By using the cloud computing environment 50 to ensure the security and ownership of the collected data, smart contracts may directly send the data from the assets to the individuals that use the data for building a machine learning model. This allows for sharing of data among the assets 378.

Furthermore, training of the machine learning model on the collected data may take rounds of refinement and testing by the host platform 376. Each round may be based on additional data or data that was not previously considered to help expand the knowledge of the machine learning model. In 372, the different training and testing steps (and the associated data) may be stored on the cloud computing environment 50 by the host platform 376. Each refinement of the machine learning model (e.g., changes in variables, weights, etc.) may be stored in the cloud computing environment 50 to provide verifiable proof of how the model was trained and what data was used to train the model. For example, the machine learning model may be stored on a blockchain to provide verifiable proof. Furthermore, when the host platform 376 has achieved a trained model, the resulting model may be stored on the cloud computing environment 50.

After the model has been trained, it may be deployed to a live environment where it can make predictions/decisions based on executing the final trained machine learning model. For example, in 374, the machine learning model may be used for condition-based maintenance (CBM) for an asset such as an aircraft, a wind turbine, a healthcare machine, and the like. In this example, data fed back from asset 378 may be input into the machine learning model and used to make event predictions such as failure events, error codes, and the like. Determinations made by executing the machine learning model at the host platform 376 may be stored on the cloud computing environment 50 to provide auditable/verifiable proof. As one non-limiting example, the machine learning model may predict a future breakdown/failure to a part of the asset 378 and create an alert or a notification to replace the part. The data behind this decision may be stored by the host platform 376 and/or on the cloud computing environment 50. In one embodiment, the features and/or the actions described and/or depicted herein can occur on or with respect to the cloud computing environment 50.

FIGS. 4A-4B illustrate processes 400 and 440 of querying a feature store for input vectors according to example embodiments. Referring to FIG. 4A, the host platform may be coupled to or otherwise include an integrated development environment (IDE) 420 or other development environment where machine learning models can be built/developed based on vectors stored in a feature store 430. The IDE 420 allows developers to write, test, and post the code to a productive/live environment and may send/receive messages to a user device 410.

According to various embodiments, the IDE 420 may enable the training of a new machine learning model or the retraining of an existing machine learning model based on vectors that are generated by the vectorization processes described herein and stored within the feature store 430. Here, the IDE 420 may output an interface 422 which may include graphical user interface (GUI) elements such as menus, sliders, bars, graphs, buttons, boxes, and the like, which can be used to input search criteria for querying the feature store 430. The criteria may include merchant-specific attributes such as merchant type, product type, category code, geographic location, sales volume, and the like, which can be used for training and for making live predictions via a machine learning model 424. The search criteria may be submitted to a query service 426, which queries the feature store 430 to obtain one or more vectors that match the search criteria from a vector database 432 of the feature store.

The vector database 432 may include a plurality of vectors which are each paired with a respective metadata of the vector. For example, as shown in FIG. 4B, a vector 452 is paired with metadata 454. Here, the metadata 454 may include descriptions of the latent features that are embedded within the vector 452, including geographic location values, merchant type values, merchant codes, sales data, transaction data, and the like. The metadata 454 may be accessed by the query service 426 when searching the features store 430 for vectors for training.

Referring again to FIG. 4B, selectable GUI elements 442, 444, and 446 within the interface 422 may provide selectable values for search criteria. In this case, the selectable elements are embodied, for example, as drop-down menus, but other GUI elements and interactive elements are also possible, including data entry fields for a keyword search. The input data/search criteria may be compared to the metadata of the vectors stored within the vector database 432. Accordingly, the metadata 454 may be used to filter out vectors that do not meet a search criteria while identifying vectors that do satisfy the search criteria. The search results (vectors) can be returned to the IDE 420 and used during the training process of the machine learning model 424.

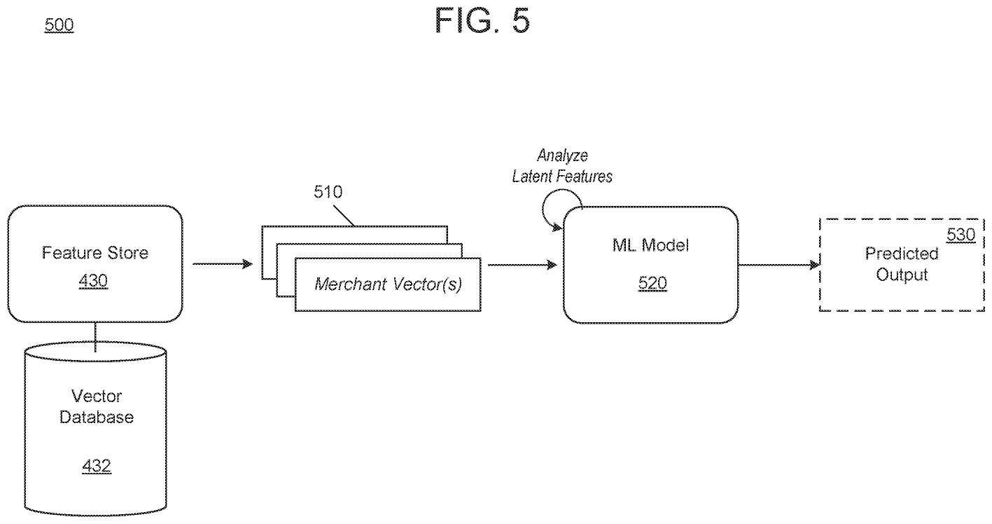

FIG. 5 illustrates a process 500 of executing a machine learning model on vectors 512 queried from the feature store 430 according to example embodiments. Referring to FIG. 5, a user may use the search system shown in FIGS. 4A and 4B to search for and identify one or more vectors 510 from the vector database 432. The one or more vectors 510 may be input to a machine learning model 520, which generates a predicted output 530 which can be analyzed for training the model. As another example, the one or more vectors 510 may be input to the machine learning model 520 to generate a predicted output 530 based on live data.

For example, the vectors (e.g., merchant vectors and/or customer vectors, etc.) may be used in data exploration and modeling. During data exploration, the host system can use vector relationships to identify a primary business for a merchant, a merchant's top competitors as well as rising competitors in that business, customer segmentation, and the like. The insights can be used to generate more features for modeling. Meanwhile, if used in modeling, each slot (dimension in the vector) can be used as a feature to be fed into the model. Furthermore, the number of slots can be modified by changing a hyperparameter of the model, for example, via the interface 422. In addition to the above situations, the machine learning model 520 can also use this information to recommend rewards and cashback for our customers to get a more personalized experience.

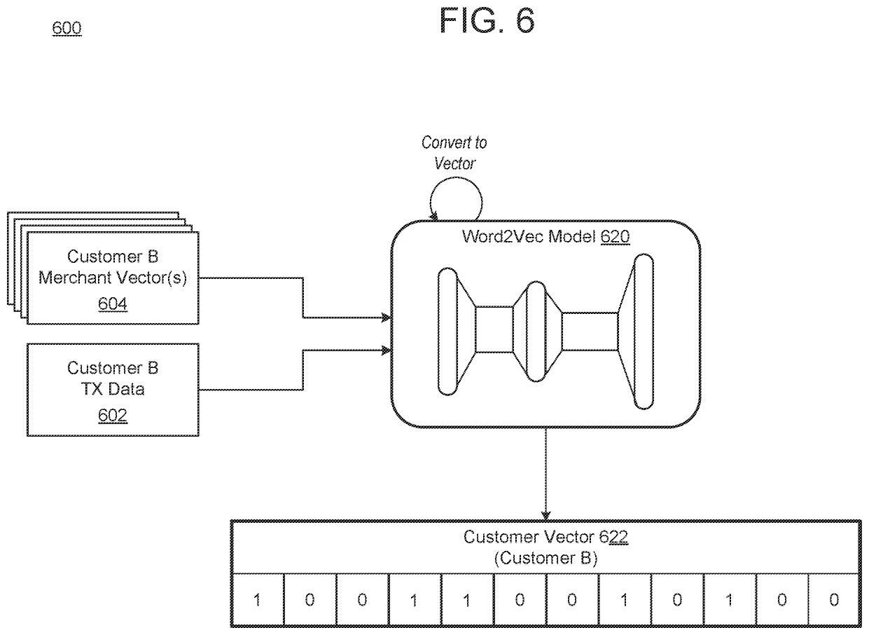

FIG. 6 illustrates a process 600 of converting transaction data into a customer vector 622 according to example embodiments. For example, the machine learning model described herein may be used to generate vectors for other entities besides merchants including customers, cardholders, and the like. Referring to FIG. 6, customer data 602, such as cardholder transactions with a merchant or merchant(s) may be input to a machine learning model 620, such as a Word2Vec model. Furthermore, one or more merchant vectors 604 may be input along with the cardholder data. The merchant vectors 604 may include vectors generated for merchants that the cardholder visits/shops with. For example, the merchant vectors, customer information, and historic transaction times may be input to the machine learning model 620, which generates/outputs a customer vector 622 which may include a one-hot representation of a customer based on merchants and merchant features of the merchants that the customer interacts with. The hidden layers are learning the connections between a customer's historical interaction with their future preference in merchants.

The example embodiments may be applied to legacy data systems to convert historical transaction content into actionable vectors which are anonymous, ready for input to a machine learning system, and provide more latent features than a traditional code. The host system can execute the model on legacy data sets to create customer vectors as a feature store table for model development. The resulting vectors take up significantly less space than the original data and provide more information. They also can be accessed by the machine learning model instead of the actual data, which can be ignored and deleted.

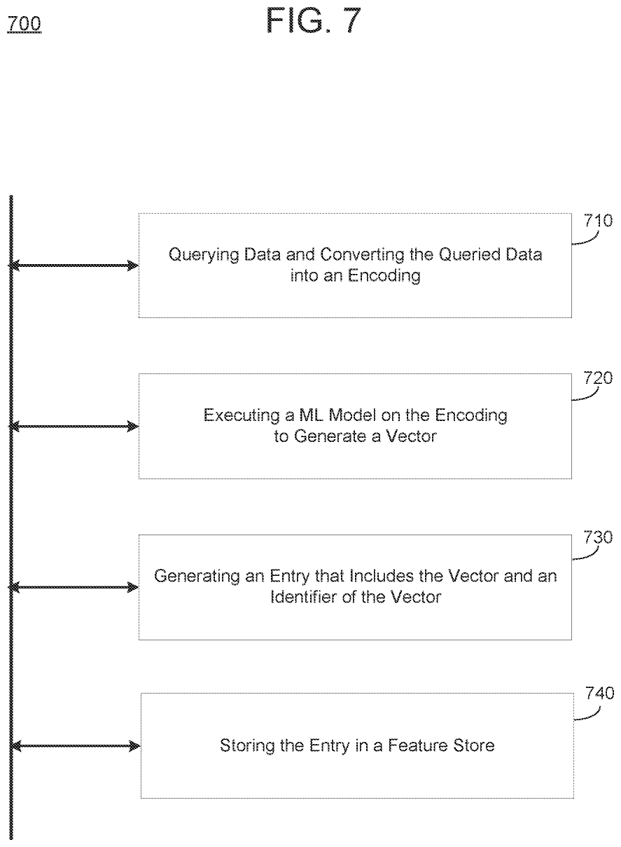

FIG. 7 illustrates a method 700 of generating a vector for a merchant based on historical data according to example embodiments, wherein the data may be transaction data. For example, the method 700 may be performed by a host platform such as a cloud platform, a web server, a database, and the like. Referring to FIG. 7, in 710, the method may include querying a merchant's data read from a merchant's point of sale (POS) system and converting the data into an encoding. In 720, the method may include executing a machine learning model on the input encoding to generate a vector that comprises vectorized values corresponding to latent features of the merchant embedded within slots of the vector, respectively. In 730, the method may include generating an entry comprising an identifier of the merchant, the context of the merchant, and the generated vector. In 740, the method may include storing the entry in the feature store.

In some embodiments, the data may include a plurality of different variations of a name of the merchant, and the method further comprises normalizing the different variations of the name of the merchant within the data into a single name value for the merchant and generating the encoding based on the single name value for the merchant. In some embodiments, the machine learning model may include a word to vector (Word2Vec) model. In some embodiments, the method may further include executing the Word2Vec model on training data to generate a weight matrix for the Word2Vec model, prior to generating the vector, and the executing comprises determining the vector based on the weight matrix for the Word2Vec model.

In some embodiments, the method may further include determining a category type of the merchant from among a plurality of possible category types, and storing the vector within a location in the feature store based on the identified category type. In some embodiments, the method may further include executing the machine learning model on data of a customer to generate a customer vector that comprises vectorized values corresponding to latent features of the customer embedded within slots of the customer vector, respectively, and storing the customer vector within the feature store. In some embodiments, the executing may include inputting the vector into the machine learning model when generating the customer vector. In some embodiments, the converting may include identifying a combination of attributes about the merchant, including a merchant name, a merchant type, and a merchant code, and converting the combination of attributes into numerical values within the encoding.

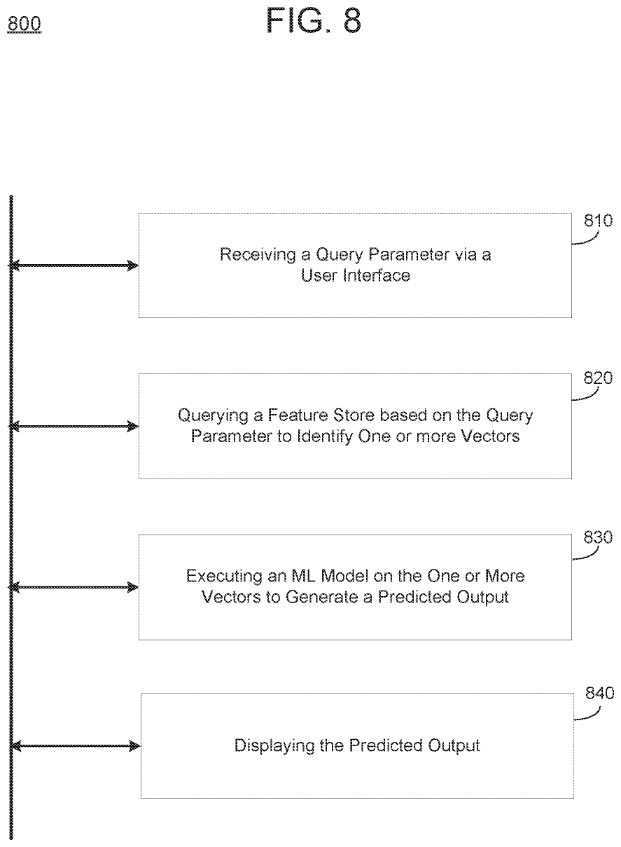

FIG. 8 illustrates a method 800 of executing a machine learning model on vectors queried from a feature store according to example embodiments. For example, the method 800 may be performed by a host platform such as a cloud platform, a web server, a database, and the like. Referring to FIG. 8, in 810, the method may include receiving a query parameter input via a software application's interface. In 820, the method may include querying the feature store based on the query parameter, wherein the querying comprises identifying one or more vectors stored in the features store that match the query parameter via execution of a query on the feature store. In 830, the method may include executing a machine learning model on the one or more vectors identified in the feature store to generate a predicted output. In 840, the method may include displaying the predicted output via the interface of the software application.

In some embodiments, the receiving may include detecting a selection of a category value via (for example) a drop-down menu of the interface, and the querying comprises identifying the one or more vectors based on a comparison of the category value to respective keywords mapped to a plurality of vectors stored in the feature store. In some embodiments, the receiving may include detecting a selection of a period of time via (for example) a drop-down menu of the interface, and the querying comprises identifying the one or more vectors based on a comparison of the period of time to respective metadata of a plurality of vectors stored in the feature store. In some embodiments, the querying may include retrieving a plurality of vectors from the feature store based on the query parameter, and the executing comprises executing the machine learning model on the plurality of vectors to train the machine learning model to perform a predictive function.

In some embodiments, the method may further include receiving a plurality of strings corresponding to a plurality of merchants, executing a second machine learning model on the plurality of strings to generate a plurality of merchant vectors corresponding to the plurality of merchants, and storing the plurality of merchant vectors in the feature store. In some embodiments, the method may further include identifying keywords associated with a merchant from among the plurality of merchants and storing the keywords within metadata of a merchant vector of the merchant in the feature store. In some embodiments, the querying may include querying the feature store via an integrated development environment (IDE), and developing a new machine learning model based on the one or more vectors identified in the feature store. In some embodiments, the executing may include comparing attributes of the one or more vectors to a predefined criteria within vector space via execution of the machine learning model on the one or more vectors.

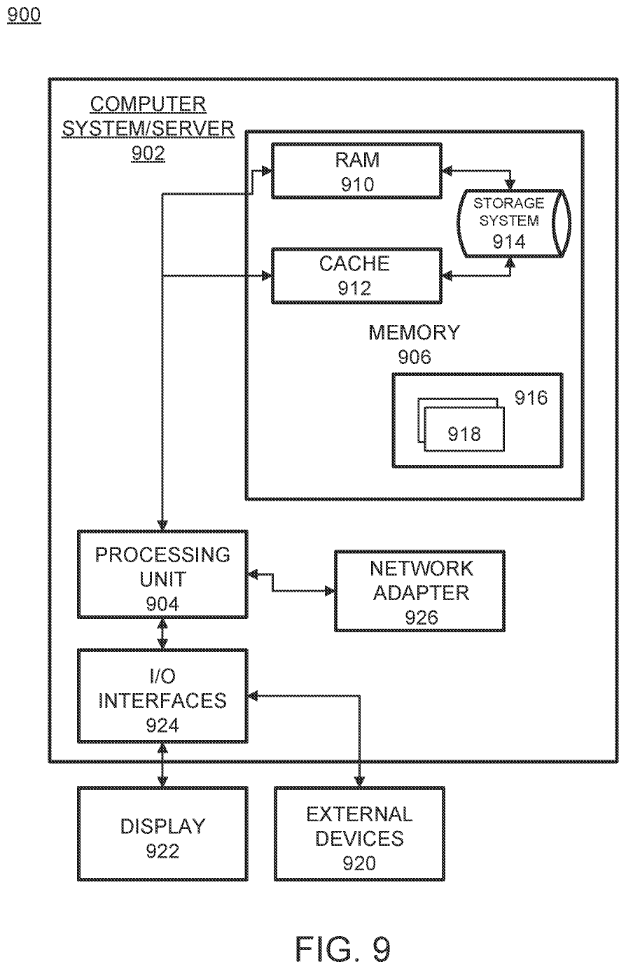

FIG. 9 illustrates an example system 900 that supports one or more of the example embodiments described and/or depicted herein. The system 900 comprises a computer system/server 902, which is operational with numerous other general-purpose or special-purpose computing system environments or configurations. Examples of well-known computing systems, environments, and/or configurations that may be suitable for use with computer system/server 902 include, but are not limited to, personal computer systems, server computer systems, thin clients, thick clients, hand-held or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Computer system/server 902 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 902 may be practiced in distributed cloud computing environments where tasks are performed by remote processing devices that are linked through a communications network. In a distributed cloud computing environment, program modules may be located in local and remote computer system storage media, including memory storage devices.

As shown in FIG. 9, computer system/server 902 in cloud computing node 900 is a general-purpose computing device. The components of computer system/server 902 may include, but are not limited to, one or more processors or processing units 904, a system memory 906, and a bus that couples various system components, including system memory 906 to processor 904.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 902 typically includes a variety of computer system readable media. Such media may be any available media that is accessible by computer system/server 902, and it includes both volatile and non-volatile media, removable and non-removable media. System memory 906, in one embodiment, implements the flow diagrams of the other figures. The system memory 906 can include computer system readable media in the form of volatile memory, such as random-access memory (RAM) 910 and/or cache memory 912. Computer system/server 902 may further include other removable/non-removable, volatile/non-volatile computer system storage media. By way of example only, storage system 914 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 906 may include at least one program product having a set (e.g., at least one) of program modules that are configured to carry out the functions of various embodiments of the application.

Program/utility 916, having a set (at least one) of program modules 918, may be stored in memory 906 by way of example, and not limitation, as well as an operating system, one or more application programs, other program modules, and program data. Each of the operating system, one or more application programs, other program modules, and program data or some combination thereof may include an implementation of a networking environment. Program modules 918 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 902 may also communicate with one or more external devices 920 such as a keyboard, a pointing device, a display 922, etc.; one or more devices that enable a user to interact with computer system/server 902; and/or any devices (e.g., network card, modem, etc.) that enable computer system/server 902 to communicate with one or more other computing devices. Such communication can occur via I/O interfaces 924. Still yet, computer system/server 902 can communicate with one or more networks, such as a local area network (LAN), a general wide area network (WAN), and/or a public network (e.g., the Internet) via network adapter 926. As depicted, network adapter 926 communicates with the other components of computer system/server 902 via a bus. It should be understood that although not shown, other hardware and/or software components could be used in conjunction with computer system/server 902. Examples include, but are not limited to: microcode, device drivers, redundant processing units, external disk drive arrays, RAID systems, tape drives, and data archival storage systems, etc.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture. They may include a transmitter, receiver, or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone, or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations, which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated within modules and embodied in any suitable form, and organized within any suitable type of data structure. The operational data may be collected as a single data set or may be distributed over different locations, including over different storage devices, and may exist, at least partially, merely as electronic signals on a system or network.

It will be readily understood that the application components, as generally described and illustrated in the figures herein, may be arranged and designed in various configurations. Thus, the detailed description of the embodiments is not intended to limit the scope of the application as claimed but is merely representative of selected embodiments of the application.

One with ordinary skill in the art will readily understand that the above may be practiced with steps in a different order and/or hardware elements in configurations that are different from those disclosed. Therefore, although the application has been described based upon these preferred embodiments, certain modifications, variations, and alternative constructions would be apparent to those of skill in the art.

While preferred embodiments of the present application have been described, it is to be understood that the embodiments described are illustrative only, and the scope of the application is to be defined solely by the appended claims when considered with a full range of equivalents and modifications (e.g., protocols, hardware devices, software platforms, etc.) thereto.

What is claimed is:

1. An apparatus comprising:
a storage device comprising a feature store; and
a processor configured to
receive a query parameter input via an interface of a software application,
query the feature store based on the query parameter, wherein the querying comprises identifying one or more vectors stored in the features store that match the query parameter via execution of a query on the feature store,
execute a machine learning model on the one or more vectors identified in the feature store to generate a predicted output, and
display the predicted output via the interface of the software application.

2. The apparatus of claim 1, wherein the processor is configured to detect a selection of a category value via a drop-down menu of the interface, and identify the one or more vectors based on a comparison of the category value to respective keywords mapped to a plurality of vectors stored in the feature store.

3. The apparatus of claim 1, wherein the processor is further configured to detect a selection of a period of time via a drop-down menu of the interface, and in response, execute the query against a plurality of vectors stored in the feature store based on a comparison of the category value to keywords of the plurality of vectors.

4. The apparatus of claim 1, wherein the processor is further configured to retrieve a plurality of vectors from the feature store based on the query parameter, and execute the machine learning model on the plurality of vectors to train the machine learning model to perform a predictive function.

5. The apparatus of claim 1, wherein the processor is further configured to receive a plurality of strings corresponding to a plurality of merchants, execute a second machine learning model on the plurality of strings to generate a plurality of merchant vectors corresponding to the plurality of merchants, and store the plurality of merchant vectors in the feature store.

6. The apparatus of claim 5, wherein the processor is further configured to identify keywords associated with a merchant from among the plurality of merchants, and store the keywords within metadata of a merchant vector of the merchant within the feature store.

7. The apparatus of claim 1, wherein the querying comprises querying the features store via an integrated development environment (IDE), and developing a machine learning model based on the one or more vectors identified in the feature store.

8. The apparatus of claim 1, wherein the processor is configured to compare attributes of the one or more vectors to a predefined criteria within vector space via execution of the machine learning model on the one or more vectors.

9. A method comprising:
receiving a query parameter input via an interface of a software application;
querying the feature store based on the query parameter, wherein the querying comprises identifying one or more vectors stored in the features store that match the query parameter via execution of a query on the feature store;
executing a machine learning model on the one or more vectors identified in the feature store to generate a predicted output; and
displaying the predicted output via the interface of the software application.

10. The method of claim 9, wherein the receiving comprises detecting a selection of a category value via a drop-down menu of the interface, and the querying comprises identifying the one or more vectors based on a comparison of the category value to respective keywords mapped to a plurality of vectors stored in the feature store.

11. The method of claim 9, wherein the receiving comprises detecting a selection of a period of time via a drop-down menu of the interface, and the querying comprises identifying the one or more vectors based on a comparison of the period of time to respective metadata of a plurality of vectors stored in the feature store.

12. The method of claim 9, wherein the querying comprises retrieving a plurality of vectors from the feature store based on the query parameter, and the executing comprises executing the machine learning model on the plurality of vectors to train the machine learning model to perform a predictive function.

13. The method of claim 9, wherein the method further comprises receiving a plurality of strings corresponding to a plurality of merchants, executing a second machine learning model on the plurality of strings to generate a plurality of merchant vectors corresponding to the plurality of merchants, and storing the plurality of merchant vectors in the feature store.

14. The method of claim 13, wherein the method further comprises identifying keywords associated with a merchant from among the plurality of merchants, and storing the keywords within metadata of a merchant vector of the merchant in the feature store.

15. The method of claim 9, wherein the querying comprises querying the feature store via an integrated development environment (IDE), and developing a new machine learning model based on the one or more vectors identified in the feature store.

16. The method of claim 9, wherein the executing comprises comparing attributes of the one or more vectors to a predefined criteria within vector space via execution of the machine learning model on the one or more vectors.

17. A computer-readable storage medium comprising instructions which when executed by a processor cause a computer to perform a method comprising:
receiving a query parameter input via an interface of a software application;
querying the feature store based on the query parameter, wherein the querying comprises identifying one or more vectors stored in the features store that match the query parameter via execution of a query on the feature store;
executing a machine learning model on the one or more vectors identified in the feature store to generate a predicted output; and
displaying the predicted output via the interface of the software application.

18. The computer-readable storage medium of claim 17, wherein the receiving comprises detecting a selection of a category value via a drop-down menu of the interface, and the querying comprises identifying the one or more vectors based on a comparison of the category value to respective keywords mapped to a plurality of vectors stored in the feature store.

19. The computer-readable storage medium of claim 17, wherein the receiving comprises detecting a selection of a period of time via a drop-down menu of the interface, and the querying comprises identifying the one or more vectors based on a comparison of the period of time to respective metadata of a plurality of vectors stored in the feature store.

20. The computer-readable storage medium of claim 17, wherein the querying comprises retrieving a plurality of vectors from the feature store based on the query parameter, and the executing comprises executing the machine learning model on the plurality of vectors to train the machine learning model to perform a predictive function.
